(19) United States
(12) Patent Application Publication
(10) Pub. No.: US 2015/0217535 A1
(43) Pub. Date: Aug. 6, 2015

(54) Prestressed Rod Stiffened Composite Structures

(71) Applicants: Mohammad Sayyar Bidgoli, East Lansing, MI (US); Anagi Manjula Balachandra, Okemos, MI (US); Parviz Soroushian, Okemos, MI (US)

(72) Inventors: Mohammad Sayyar Bidgoli, East Lansing, MI (US); Anagi Manjula Balachandra, Okemos, MI (US); Parviz Soroushian, Okemos, MI (US)

(73) Assignee: METNA CO, Lansing, MI (US)

(21) Appl. No.: 13/592,767

(22) Filed: Aug. 23, 2012

(51) Int. Cl. B32B 5/22; B32B 1/00

(52) U.S. Cl. CPC B32B 5/22; B32B 1/00; B32B 2262/103; B32B 2262/105; B32B 2262/062; B32B 2262/0253; B32B 2262/106; B32B 2262/10; B32B 2262/0269; B32B 2262/101; B32B 2262/0276; B32B 2262/0292; B32B 2262/0284; B32B 2262/02

(57) ABSTRACT

A structurally efficient rod-stiffened panel incorporating pretressing benefits is provided, the prestress provided by pultruded rod which is already in the system. The pultruded rods being retained in either tension or compression stresses apply prestressing via interfacial behavior. The new system improves the efficiency of structural composites by tailoring the stress system within structure to fully utilize the structural potential of various components, and to avoid premature local failures within composite structures. A method for producing a prestressed rod stiffened composite structure is also provided.

### STATEMENT REGARDING FEDERALLY SPONSORED RESEARCH & DEVELOPMENT

This invention was made with U.S. government support under Contracts FA8650-09-C-3908 by the U.S. Air Force. The U.S. government has certain rights in the invention.

### CROSS-REFERENCE RELATED TO THIS APPLICATIONS

Not applicable.

### BACKGROUND OF THE INVENTION

U.S. Patent Application Publication No. US 2011/0039057 Al to Frisch, et al, describes a laminated composite panel stiffened with composite rods with unidirectional fiber reinforcement.

This system does not use the full strength of rods which have higher elastic modulus and strength than the laminated composite. According to the method of the present invention, the high strength rod is used for prestressing the rods stiffened laminated composite panel for achieving higher level of structural efficiency by refining the stress system developed under failure loads in the laminated composite stiffened with rods.

An application of prestressing to wood composite laminate is found in U.S. patent Ser. No. 09/174,888 issued to Karisallen et al. In this application, prestresing is applied to wood strands via fibers which are added to the system for prestressing purposes. Fibers are pretensioned in this application, adhered to wood strands, and then their tension is released in order to precompress the wood strands. This pretensioning effect alters the failure mode of wood strands from tensile to compressive, which makes the failure process more ductile. In the present invention, the pultruded rod which is used as prestressing element is part of the original structure; hence prestressing is applied to the system without the weight and cost penalties associated with introduction of new prestressing element and adhering these elements to the original structure.

The present invention, unlike the method presented by James et al., applies an eccentric prestressing force which improves the structural efficiency of prestressing when compared with concentric prestressing that applies uniform stress on the structure. The configuration of the structure in the prestress invenstion allows for prestressing via application of either tensile or compressive force to the pultruded rod (the prestessing element), which the method presented by James et al. allows for only application of tensile force to prestressing element.

An application of prestressed structures is found in U.S. patent Ser. No. 07/186,434 issued to Rechards et al. which discloses a lightweight structural member made of prestressed plastic foam, wherein prestressing is provided by a plurality of tendons disposed within the foam to which tensile forces are applied during mold casting of the structural member. The tendons are retained in tension by bonding between the tendons and the foam, or by way of anchors which are spaced along the tendons to retain the tendons in immobile condition, one or more skin layers also being optionally provided. The need for the tendons and the requirement for bonding or anchorage of tendons to the structure carry weight and cost penalties. In the present invention, on the other hand, the prestressing rods are already present in the original structure system and thus prestressing does not require introduction of new element and their bonding to the original structure. Also, the prestressing method presented for plastic foams can not be used for thin composite structures. Also, the method presented by Richards et al. allows only for application of tension to prestressing tendons, which the present invention allows for application of either tensile or compressive forces to the prestressing elements.

### SUMMARY OF THE INVENTION

The above and other objects of the present invention are accomplished by providing a prestressed composite structural member and a method of making a structural member of this type. Structural members according to the present invention are fabricated by assembling a rod stiffened panel preform comprising at least one of stitched composite structure, and pre-cured rods having a generally circular or oval cross-section. The prestressing force is applied by tensioning or compressing pultruded rods and transferring their force via interfacial bond stress to the remainder of the composite structure. The effect of forces in pultruded rods are balances by those of forces in the remainder of the composite structure. Pultruded rods can be stressed prior to or after curing of the composite structures. An important consideration is development of adequate interfacial bond strength for transfer of the prestress force from pultruded bars to the remainder of the composite structures.

The prestressed rod stiffened composite structures produced by the method of the present invention provide higher structural performance comparing to identical non-prestressed structures. This gain in performance is realized because the prestress system counteracts the governing stress system developed in the structure under critical service loads. Prestressing of PRSEUS also enables effective use of the structural qualities of pultruded rods, which are higher than those of the remainder of the structure.

Structural members according to present invention will resemble non-prestressed members. The new system improves the efficiency of structural composites by tailoring the stress system within structure to fully utilize the structural potential of various components, and to avoid premature local failures within composite structures.

### BRIEF DESCRIPTION OF THE DRAWINGS

FIG. 1 is a processing of a prestressed rod-stiffened structure

FIG. 2 is a prestressing end grip

FIG. 3 is a prestressing device for pretensioned rod.

FIG. 4 is infusion of a prestressed rod stiffened structure

FIG. 5 is a perspective view of an infused multiaxial composite with a hole

FIG. 6 is a prestressing device for precompressioned rod

### INVENTION EXAMPLES

### Example 1

### Rod Stiffened Composite Panel with Pretensioned Rod

This example presents an approach implemented for production of prestressed rod stiffened composite panels.

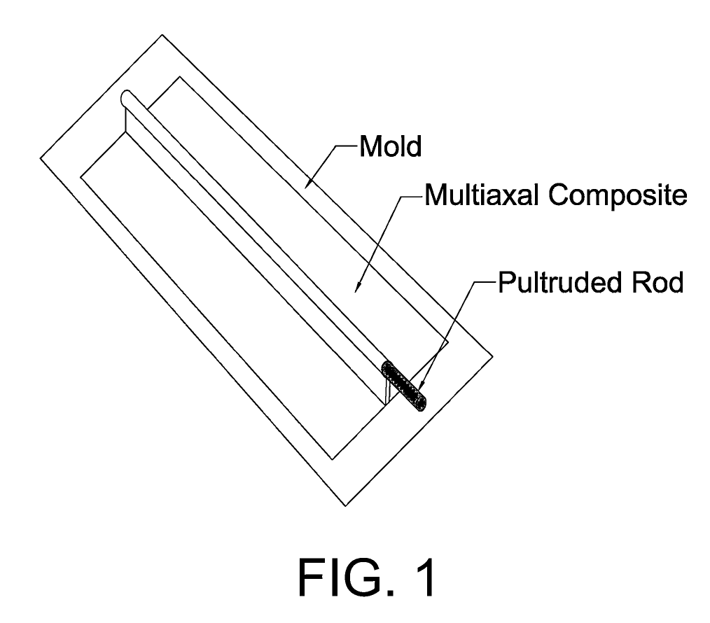

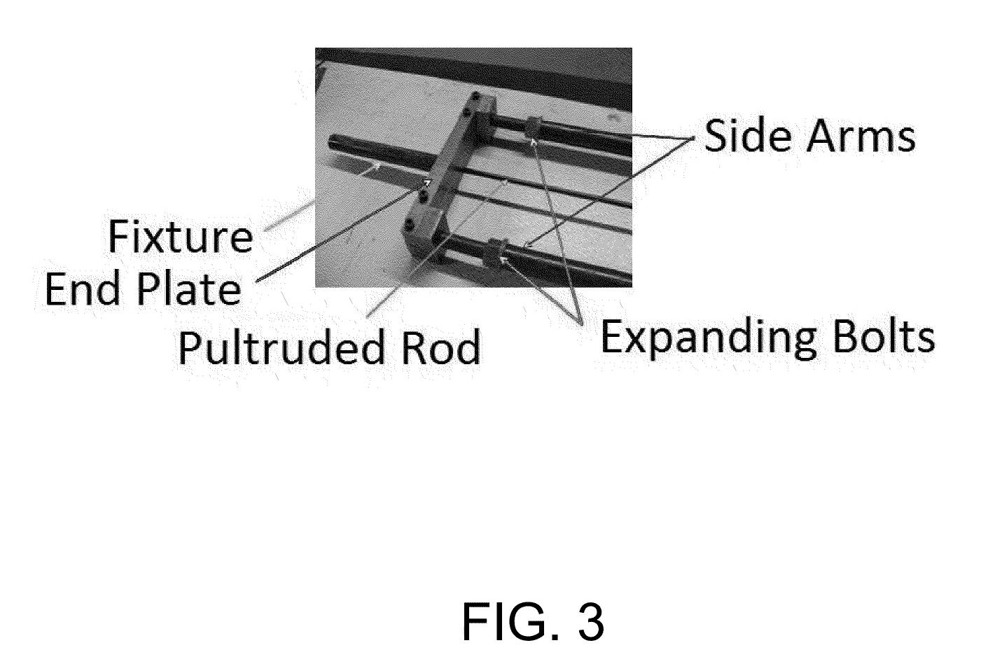

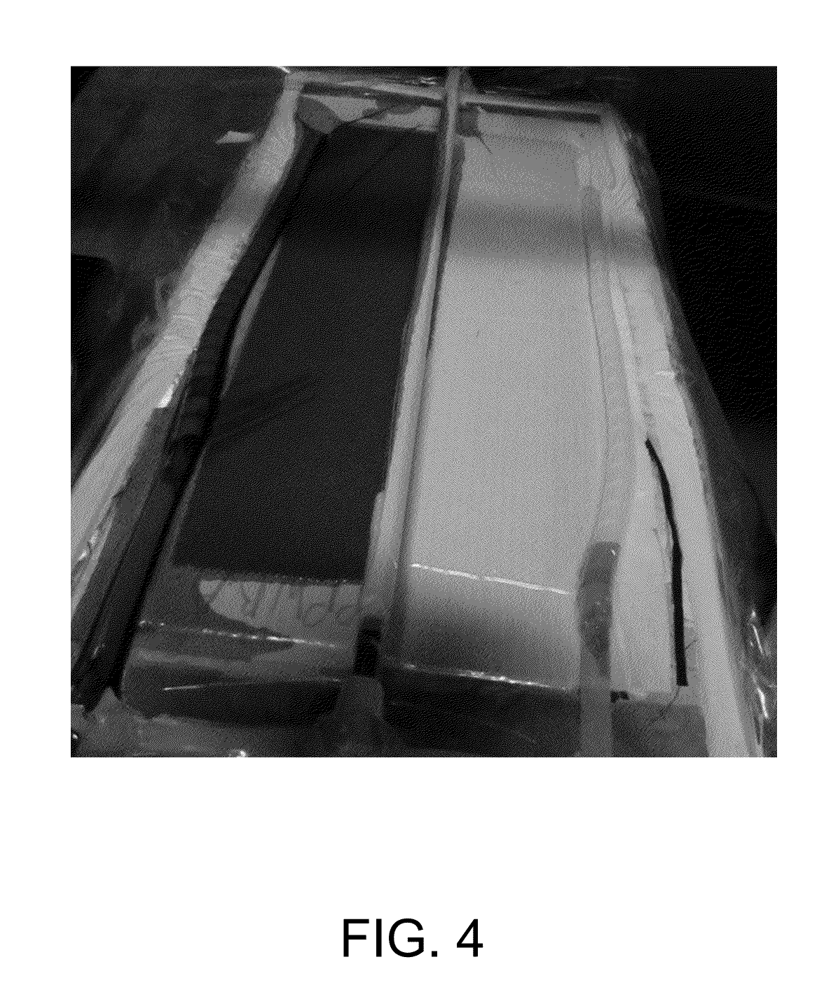

The first step involves preparation of a dry preform comprising an assembly of multiaxial carbon fiber fabrics and a uniaxial carbon fiber composite rod (FIG. 1). In order to apply presstressing force to the rod, metal tubes are mounted at both ends on the rod which enabled transfer of the prestressing force via interfacial shear. The metal tubes are filled with high-performance epoxy. The tensile prestressing force is applied to the rod via metal tubes using a prestressing frame (FIG. 3). This prestressing force is sustained as epoxy resin was infused into the preform assembly and then cured (FIG. 4). After curing of the infused resin, the prestressing force applied to metal tubes is released, which leads to transfer of the prestressing force to the multiaxial composite via interfacial shear between the rod and the multiaxial composite panel.

### Example 2

### Rod Stiffened Composite Panel with Pretensioned Rod

This Example illustrates the approach adopted for production of a prestressed rod-stiffened composite panel with precompressioned rod.

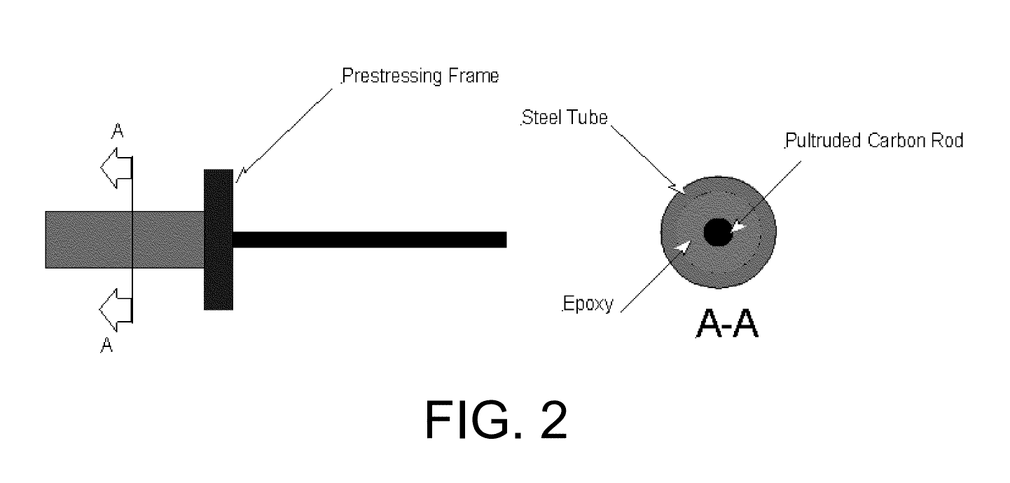

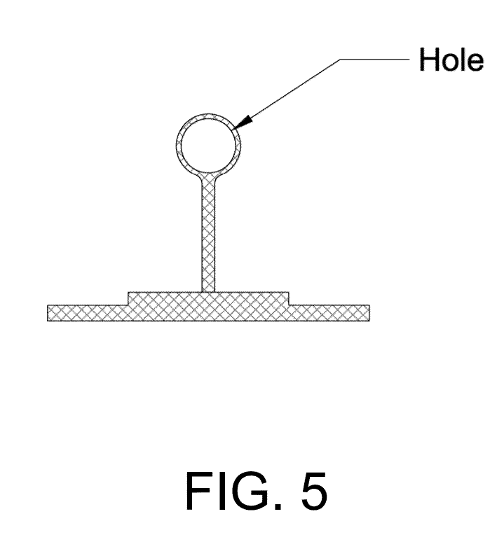

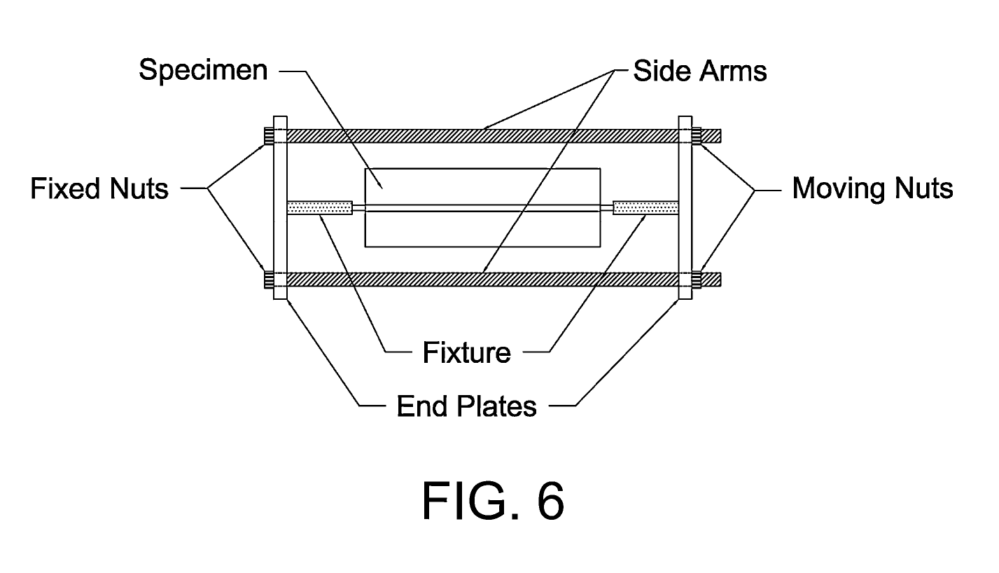

The fabrication begins with prepration of a dry preform using multiaxial carbon fiber fabrics in conjunction with a unidirectional carbon fiber composite rod which is covered with PTFE tube. This assembly is similar to FIG. 1, except for covering of the rod with PTFE. This PTFE cover prevents bonding between the rod and the multiaxial component during resin infusion and curing of the multiaxial fabric. After curing of the epoxy resin, the rod is removed, leaving the multiaxial composite with an empty hole (FIG. 5). A uniaxial fiber composite rod wrapped with an adhesive agent is inserted into the hole. Metal tubes are then mounted at the rod ends, and filled with high-performance epoxy for establishing bonds between the metal tubes and the rod (FIG. 2). This enables application of prestressing force to the rod (i.e. precompressing the rod) via interfacial shear. The prestressing force is applied to the end tubes using a prestressing frame (FIG. 6). With the prestressing force sustained, the specimen is subjected to elevated temperature for curing of the adhesive agent and establishing bond between the precompressed rod and the multiaxial composite component of the structure. Once the bond is established, the presressing force applied at the rod ends is released, leading the prestressing (Pretensioning) of the multiaxial composite with force transfer occurring, via interfacial shear.

What is claimed is:

1. A prestressed rod-stiffened composite panel comprising
unidirectional fiber composite elements, generally at least one of cylindrical rods, oval rods and cylindrical tubes;
a multiaxial fiber composite constituent comprising skin and stiffeners, where the stiffeners wrap around and bond to said unidirectional composite elements;
where the multiaxial fiber composite constituent and the unidirectional fiber composite element are subjected to opposite prestressing forces for improving the structural performance of the rod-stiffened composite panel;
wherein said prestressing forces are applied to the unidirectional fiber composite elements using at least one of thermo-mechanical and hydraulic methods, with said forces balanced against reactions applied to temporary external supports before establishing bond between the unidirectional fiber composite elements and the multiaxial fiber composite constituent, followed by establishing said bond and then removal of said temporary external supports in order to balance the prestressing force in the unidirectional fiber composite elements with an opposite prestressing force applied to the multiaxial fiber composite constituent via bond shear stresses.

2. The prestressed rod-stiffened composite panel of claim 1, wherein said multiaxial fiber composite constituent and said unidirectional fiber composite elements are made with at least one of metal, ceramic, polymer, cellulose, polypropylene, basalt, polyethylene and carbon fiber, and at least one of polymer, ceramic, metal and carbon matrices.
2-B—The prestressed rod-stiffened composite panel of claim 1, wherein said multiaxial fiber composite constituent and said unidirectional fiber composite elements are made with at least one of carbon, glass, aramid, boron, steel, alumina, ceramic, silicon carbide, cellulose, and at least one of, ceramic, metal, epoxy, polyamide, Polyester, vinyl ester, bismalamide, polyetherketane, polyether, polyurethane, polyimide, polysolfone, polyethylenetrepthalate, polypropylene, polypropylene, polycarbonate, nylon and polyethersulfone matrices.

3. The prestressed rod-stiffened composite panel of claim 1, wherein said bond between the multiaxial fiber composite constituent and said unidirectional fiber composite elements is formed using at least one of adhesive bonding, fusion, mechanical interlocking, friction and chemical bonding mechanisms.

4. The prestressed rod-stiffened composite panel of claim 1, wherein said stiffeners are at least one of blade, L inverse stiffeners and hat stiffeners which incorporate the unidirectional fiber composite elements.

5. The prestressed rod-stiffened composite panel of claim 1, wherein said unidirectional fiber composite elements are subjected to at least one of compressive and tensile prestressing forces;

6. The prestressed rod-stiffened composite panel of claim 1, wherein said unidirectional fiber composite elements are subjected to compressive prestressing forces, and said elements are supported against buckling by at least one of external support and the multiaxial fiber composite constituent.

7. The prestressed rod-stiffened composite panel of claim 1, wherein said panel includes flat panel and curved panel.

8. A prestressed stiffened composite panel comprising a multiaxial fiber composite akin and fiber reinforced composite skins;
wherein said skin and stiffeners exhibit differences in at least one of thermal expansion and creep characters;
where, said prestressed stiffened composite is subjected to prestressing forces by subjecting the panel to at least one of mechanical force and temperature rise sustained overtime, followed by removal of said mechanical force and temperature rise.

9. The prestressed stiffened composite panel of claim 7, wherein said stiffeners are at least one of rod, L-inverse, hat, and blade stiffeners.

10. The prestressed stiffened composite panel of claim 7, wherein said stiffeners are made of at least one of multiaxial fiber composites and unidirectional fiber composites.

11. The prestressed rod-stiffened composite panel of claim 1, wherein said multiaxial fiber composite constituent and said unidirectional fiber composite elements are made with at least one of metal, ceramic, polymer, cellulose, polypropylene, basalt, polyethylene and carbon fiber, and at least one of polymer, ceramic, metal and carbon matrices.
2-B—The prestressed rod-stiffened composite panel of claim 1, wherein said multiaxial fiber composite constituent and said unidirectional fiber composite elements are made with at least one of carbon, glass, aramid, boron, steel, alumina, ceramic, silicon carbide, cellulose, and at least one of, ceramic, metal, epoxy, polyamide, Polyester, vinyl ester, bismalamide, polyetherketane, polyether, polyurethane, polyimide, polysolfone, polyethylenetrepthalate, polypropylene, polypropylene, polycarbonate, nylon and polyethersulfone matrices.

12. The prestressed stiffened composite panel of claim 7, wherein said panel includes flat panel and curved panel.
